(19) United States
(12) Patent Application Publication
(10) Pub. No.: US 2020/0094979 A1
(43) Pub. Date: Mar. 26, 2020

(54) UNMANNED AERIAL VEHICLE CHARGING CONTROL METHOD, SYSTEM AND UNMANNED AERIAL VEHICLE

(71) Applicant: SZ DJI TECHNOLOGY CO., LTD., Shenzhen (CN)

(72) Inventors: Dayang Zheng, Shenzhen (CN); Ru Gong, Shenzhen (CN); Wentao Wang, Shenzhen (CN)

(21) Appl. No.: 16/678,863

(22) Filed: Nov. 8, 2019

Related U.S. Application Data
(63) Continuation of application No. PCT/CN2017/083769, filed on May 10, 2017.

(51) Int. Cl. B64D 27/24; B64C 39/02; B64D 31/00; H02J 7/00

(52) U.S. Cl. CPC B64D 27/24; B64C 39/024; B64C 2201/127; H02J 7/0068; B64C 2201/042; B64D 31/00

(57) ABSTRACT

An unmanned aerial vehicle (UAV) charging control method includes detecting whether a battery of a UAV is electrically connected to an external power supply, disconnecting a load power supply circuit in response to detecting that the battery is electrically connected to the external power supply, and controlling the battery to be charged by the external power supply. The load power supply circuit is configured for the battery to supply power to a load of the UAV.

### CROSS REFERENCE TO RELATED APPLICATION

This application is a continuation of International Application No. PCT/CN2017/083769, filed on May 10, 2017, the entire content of which is incorporated herein by reference.

### TECHNICAL FIELD

The present disclosure relates to the field of unmanned aerial vehicle and, more particularly, to an unmanned aerial vehicle charging control method and system, and an unmanned aerial vehicle.

### BACKGROUND

A current unmanned aerial vehicles (UAV) is powered by its on-board battery. However, the UAV on-board battery has limited capacity and can only support 20 to 30 minutes of operation. To ensure consecutive operation of the UAV for an extended period of time, the UAV on-board battery is recharged on-site by a portable charging system. Currently, the UAV is often recharged in a sealed compartment of the portable charging system. However, during the charging process, the UAV dissipates heat, thereby degrading battery charging efficiency.

### SUMMARY

In accordance with the disclosure, there is provided an unmanned aerial vehicle (UAV) charging control method including detecting whether a battery of a UAV is electrically connected to an external power supply, disconnecting a load power supply circuit in response to detecting that the battery is electrically connected to the external power supply, and controlling the battery to be charged by the external power supply. The load power supply circuit is configured for the battery to supply power to a load of the UAV.

Also in accordance with the disclosure, there is provided an unmanned aerial vehicle (UAV) including a battery, a load connected to the battery, and a control system connected to the battery. The control system is configured to disconnect a load power supply circuit in response to detecting that the battery is electrically connected to an external power supply and control the battery to be charged by the external power supply. The load power supply circuit is configured for the battery to supply power to the load.

Also in accordance with the disclosure, there is provided an unmanned aerial vehicle (UAV) charging control system including an external power supply and a UAV. The UAV includes a battery, a load connected to the battery, and a control system connected to the battery. The control system is configured to disconnect a load power supply circuit in response to detecting that the battery is electrically connected to an external power supply and control the battery to be charged by the external power supply. The load power supply circuit is configured for the battery to supply power to the load.

### BRIEF DESCRIPTION OF THE DRAWINGS

To more clearly illustrate the technical solution of the present disclosure, the accompanying drawings used in the description of the disclosed embodiments are briefly described hereinafter. The drawings described below are merely some embodiments of the present disclosure. Other drawings may be derived from such drawings by a person with ordinary skill in the art without creative efforts and may be encompassed in the present disclosure.

FIG. 1 is a flowchart of an unmanned aerial vehicle (UAV) charging control method according to an example embodiment of the present disclosure.

FIG. 2 is a schematic view of a UAV according to an example embodiment of the present disclosure.

FIG. 3 is a schematic view of a UAV according to another example embodiment of the present disclosure.

FIG. 4 is a schematic view of a UAV according to another example embodiment of the present disclosure.

FIG. 5 is a schematic view of a UAV charging control system according to an example embodiment of the present disclosure.

FIG. 6 is a schematic view of another UAV charging control system according to another example embodiment of the present disclosure.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

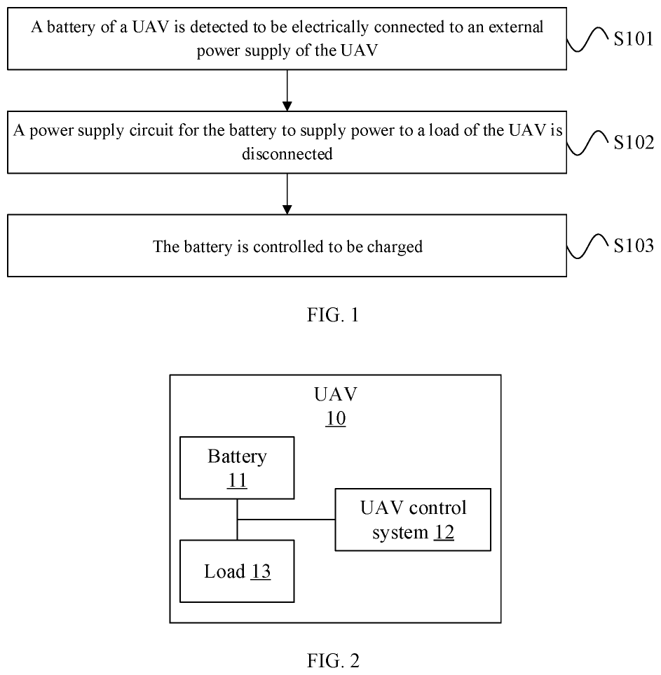

FIG. 1 is a flowchart of a UAV charging control method according to an example embodiment of the present disclosure. The method will be described in more detail below.

At S101: a battery of a UAV is detected to be electrically connected to an external power supply of the UAV.

At S102: a power supply circuit for the battery to supply power to a load of the UAV (also referred to as a “UAV load”) is disconnected. This power supply circuit is also referred to as a “load power supply circuit.”

At S103: the battery is controlled to be recharged.

In some embodiments, whether the UAV battery is electrically connected to the external power supply of the UAV may be detected. The external power supply may be a portable charging system, such as a portable charging system specialized for UAVs. For example, the electrical connection between the UAV battery and the portable charging system may be electrical connection between a battery communication interface and a communication interface of the portable charging system. In this case, whether the battery communication interface is electrically connected to the communication interface of the portable charging system can be detected to determine whether the UAV battery is electrically connected to the portable charging system. That is, if the battery communication interface is electrically connected to the communication interface of the portable charging system, it indicates that the battery is electrically connected to the portable charging system. If the battery communication interface is not electrically connected to the communication interface of the portable charging system, it indicates that the battery is not electrically connected to the portable charging system. After the UAV battery is detected to be electrically connected to the external power supply of the UAV, it indicates that the external power supply is going to charge the battery. Then, in some embodiments, the power supply circuit for the battery to supply power to the UAV load is disconnected, such that the battery no longer supplies power to the load to avoid consumption of the battery energy. In some embodiments, the battery is controlled to be charged. Because the load does not consume the battery energy, battery charging efficiency is increased. If the battery continues to supply power to the load, the battery energy consumed by the load may generate heat. The heat may accumulate in a sealed compartment of the portable charging system to raise an ambient temperature of the battery to a harmful level. Thus, during a battery charging process, the battery is controlled not to supply power to the load, thereby reducing the heat generation and improving battery charging safety.

In some embodiments, whether the UAV battery is electrically connected to the external power supply is detected. If so, the power supply circuit for the battery to supply power to the UAV load is disconnected, and the battery is controlled to be charged. Thus, the battery charging efficiency is improved, the heat generation in the battery charging process is reduced, and the battery charging safety is improved.

In some embodiments, after the battery of the UAV is detected to be electrically connected to the external power supply (S101), S104 may be executed, as described below.

At S104: a power supply circuit for the battery to supply power to a UAV control system of the UAV is controlled to remain connected. This power supply circuit is also referred to as a “control system power supply circuit.”

In some embodiments, although the UAV battery is detected to be electrically connected to the external power supply of the UAV and the power supply circuit for the battery to supply power to the UAV load is disconnected, the power supply circuit for the battery to supply power to the UAV control system of the UAV remains connected. That is, the power supply circuit for the battery to supply power to the UAV control system is not disconnected, such that the UAV control system operates normally. As such, during the battery charging process, the UAV control system maintains control of the battery to avoid accidents.

It should be noted that S104 may be executed before or after or at the same time as the execution of S102 and S103.

In some embodiments, in addition to keeping connected the power supply circuit for the battery to supply power to the UAV control system of the UAV, the UAV control system is controlled to operate in a low-power sleep mode, such that although the battery continues to supply power to the UAV control system, the UAV control system consumes very little power in the low-power sleep mode, thereby further improving the battery charging efficiency.

In some embodiments, the method further includes S105 and S106, as described below.

At S105: the battery is detected to be electrically disconnected from the external power supply.

At S106: the power supply circuit for the battery to supply power to the load is connected.

In some embodiments, after the power supply circuit of the battery that supplies power to the load is disconnected, whether the battery is electrically connected to the external power supply continues to be detected. For example, whether the battery communication interface is electrically connected to the communication interface of the external power supply is detected to determine whether the battery is electrically connected to the external power supply. When it is detected that the battery communication interface is not electrically connected to the communication interface of the external power supply, it is determined that the battery is electrically disconnected from the external power supply. In this case, the external power supply is not charging the battery. Thus, the consumption of the battery power does not affect the battery charging efficiency. Hence, the power supply circuit for the battery to supply power to the load is connected, such that the load may operate normally to satisfy needs of the normal operation of the UAV.

In some embodiments, an electronic switch is electrically coupled between the UAV battery and the load of the UAV. The electronic switch may control the connection and disconnection of the power supply circuit for the battery to supply power to the load.

In some embodiments, S102 includes controlling the electronic switch to open (i.e., to be off). That is, after the UAV battery is detected to be electrically connected to the external power supply of the UAV, the electronic switch is controlled to disconnect the power supply circuit for the battery to supply power to the load. Thus, the battery is unable to supply power to the load of the UAV.

In some embodiments, S106 includes controlling the electronic switch to close (i.e., to be on). That is, when the UAV battery is detected to have been electrically disconnected from the external power supply of the UAV, the electronic switch is controlled to connect the power supply circuit for the battery to supply power to the load. Thus, the battery supplies power to the load of the UAV.

In some embodiments, the electronic switch may be a metal-oxide-semiconductor (MOS) transistor or a solid-state relay.

In some embodiments, the load may be at least one of a gimbal, a camera, an electronic speed control (ESC) circuit, a distance sensor, or a positioning sensor. The load is not limited thereto and may include other circuits in the UAV that consume power.

The distance sensor may include a radar, a binocular sensor, a monocular sensor, an infrared sensor, or a supersonic sensor, etc.

The positioning sensor may include an inertial measurement unit (IMU), a global positioning system (GPS), or a compass, etc.

In some embodiments, before the UAV battery is electrically connected to the external power supply, the UAV is in an operation state. When the UAV is in the operation state, the power supply circuit for the battery to supply power to the load is connected. Thus, when the UAV battery is detected to be electrically connected to the external power supply, whether the UAV is in the operation state is detected. If it is detected that the UAV is in the operation state, it indicates that the power supply circuit for the battery to supply power to the load is connected, and then the power supply circuit for the battery to supply power to the load is disconnected. In addition, if the UAV is in the operation state, the power supply circuit for the battery to supply power to the UAV control system of the UAV is connected. When the UAV is detected to be in the operation state, the power supply circuit for the battery to supply power to the UAV control system continues to be connected.

In some other embodiments, before the UAV battery is electrically connected to the external power supply, the UAV is in a shutdown state. When the UAV is in the shutdown state, the power supply circuit for the battery to supply power to the load of the UAV is disconnected. Thus, when the UAV battery is detected to be electrically connected to the external power supply, whether the UAV is in the operation state or in the shutdown state is detected. If it is detected that the UAV is in the shutdown state, in order to control the battery during the charging process, the UAV is controlled to switch from the shutdown state to the operation state. Since the power supply circuit for the battery to supply power to the load is connected in the operation state, the power supply circuit for the battery to supply power to the load is disconnected. In addition, since the power supply circuit for the battery to supply power to the UAV control system of the UAV is connected when the UAV is in the operation state, the power supply circuit for the battery to supply power to the UAV control system is controlled to remain connected.

Therefore, regardless of whether the UAV is in the operation state or in the shutdown state, when the external power supply recharges the UAV battery, the UAV enters the low-power sleep mode, thereby improving the battery charging efficiency and the battery charging safety.

FIG. 2 is a schematic view of a UAV according to an example embodiment of the present disclosure. As shown in FIG. 2, the UAV 10 includes a battery 11, a UAV control system 12, and a load 13. The UAV control system 12 is connected to the battery 11 and the load 13 is connected to the battery 11.

The UAV control system 12 disconnects the power supply circuit for the battery 11 to supply power to the load 13 when it is detected that the battery 11 is electrically connected to the external power supply and controls the battery 11 during the charging process.

In some embodiments, the UAV control system also keeps the power supply circuit connected for the battery 11 to supply power to the UAV control system 12 during the charging process of the battery 11.

In some embodiments, the UAV control system 12 is also controlled to enter the low-power sleep mode.

In some embodiments, the UAV control system 12 also detects that the battery 11 has been electrically disconnected from the external power supply and connects the power supply circuit for the battery 11 to supply power to the load 13.

In some embodiments, the UAV control system 12 also disconnects the power supply circuit for the battery 11 to supply power to the load 13 when detecting that the UAV 10 is in the operation state.

In some embodiments, when the UAV 10 is detected to be in the shutdown state, the UAV control system 12 also controls the UAV 10 to switch from the shutdown state to the operation state and disconnects the power supply circuit for the battery 11 to supply power to the load 13.

The UAV provided by the embodiments of the present disclosure may be used to implement the technical solutions of the foregoing method embodiments. The implementation principle and technical effects thereof are similar and are not described in detail herein.

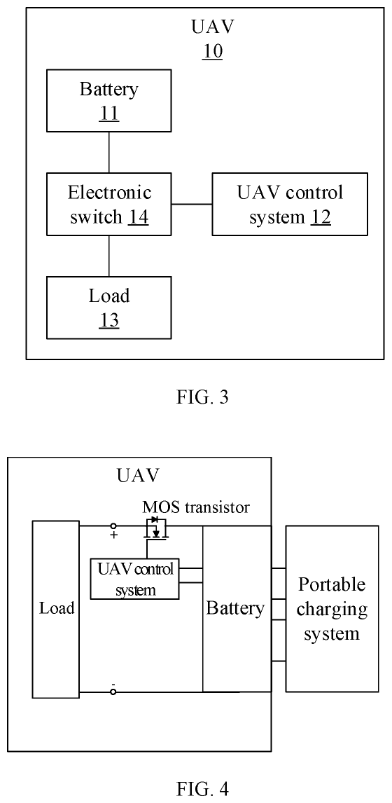

FIG. 3 is a schematic view of a UAV according to another example embodiment of the present disclosure. The UAV in FIG. 3 is similar to the UAV in FIG. 2. In addition, an electronic switch 14 is electrically coupled between the battery 11 and the load 13. The UAV control system 12 is communicatively coupled to the electronic switch 14.

The UAV control system 12 also controls opening and closing of the electronic switch 14.

In some embodiments, the electronic switch 14 may be a MOS transistor. FIG. 4 schematically shows an example UAV according to another example embodiment of the present disclosure, in which the electronic switch 14 is a MOS transistor.

In some embodiments, the electronic switch 14 may be a solid-state relay.

In some embodiments, the load 13 includes at least one of a gimbal, a camera, an electronic speed control circuit, a distance sensor, or a positioning sensor.

The UAV provided by the embodiments of the present disclosure may be used to implement the technical solutions of the foregoing method embodiments. The implementation principle and technical effects thereof are similar and are not described in detail herein.

In some embodiments, the UAV 10 also includes a fuselage and a power system, etc., which are not shown. The battery 11 can be disposed in a battery compartment of the fuselage of the UAV 10.

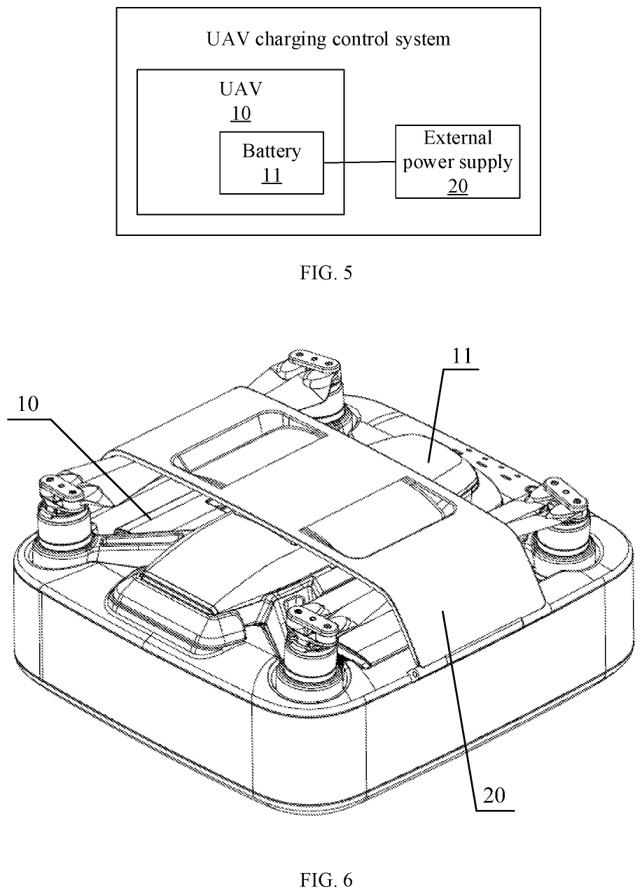

FIG. 5 is a schematic view of a UAV charging control system according to an example embodiment of the present disclosure. As shown in FIG. 5, the UAV charging control system includes a UAV 10 and an external power supply 20. The external power supply 20 can charge the battery 11 of the UAV 10. The UAV 10 may be any of the UAVs described above in connection with FIGS. 2-4 and correspondingly, may implement the technical solutions of the foregoing method embodiments. The implementation principle and technical effects thereof are similar and are not described in detail herein.

In some embodiments, the external power supply may be a portable charging system, such as a portable charging system specialized for UAVs. FIG. 6 illustrates a diagram showing the UAV 10 being recharged by a portable charging system as the external power supply 20.

It should be understood by those skilled in the art that all or part of the steps of the foregoing method embodiments may be implemented in hardware instructed by program instructions. The program may be stored in a computer readable storage medium. When being executed, the program performs the steps in the foregoing method embodiments. The storage medium may include a read-only memory (ROM), a random-access memory (RAM), a magnetic disk, an optical disk, or various other storage medium for storing the program.

The foregoing descriptions are merely some implementation manners of the present disclosure, but the scope of the present disclosure is not limited thereto. While the embodiments of the present disclosure have been described in detail, those skilled in the art may appreciate that the technical solutions described in the foregoing embodiments may be modified or equivalently substituted for some or all the technical features. And the modifications or substitutions do not depart from the scope of the technical solutions of the embodiments of the present disclosure.

What is claimed is:

1. An unmanned aerial vehicle (UAV) charging control method comprising:
detecting whether a battery of a UAV is electrically connected to an external power supply;
in response to detecting that the battery is electrically connected to the external power supply, disconnecting a load power supply circuit configured for the battery to supply power to a load of the UAV; and
controlling the battery to be charged by the external power supply.

2. The method of claim 1, further comprising:
keeping a control system power supply circuit connected, the control system power supply circuit being configured for the battery to supply power to a control system of the UAV.

3. The method of claim 2, further comprising:
controlling the control system to enter a low-power sleeping mode.

4. The method of claim 1, further comprising, after controlling the battery to be charged:
detecting that the battery is electrically disconnected from the external power supply; and
connecting the load power supply circuit.

5. The method of claim 1,
wherein the load power supply circuit includes an electronic switch electrically coupled between the battery and the load;
the method further comprising:
disconnecting the load power supply circuit includes controlling the electronic switch to open.

6. The method of claim 5, wherein the electronic switch includes a MOS transistor or a solid-state relay.

7. The method of claim 1, wherein the load includes at least one of a gimbal, a camera, an electronic speed control (ESC) circuit, a distance sensor, or a positioning sensor.

8. The method of claim 1, wherein the external power supply includes a portable charging system.

9. The method of claim 1, wherein disconnecting the load power supply circuit includes:
disconnecting the load power supply circuit in response to detecting that the UAV is in an operation state.

10. The method of claim 1, wherein disconnecting the load power supply circuit includes:
in response to detecting that the UAV is in a shutdown state, controlling the UAV to switch from the shutdown state to an operation state; and
disconnecting the load power supply circuit after the UAV is switched to the operation state.

11. An unmanned aerial vehicle (UAV) comprising:
a battery;
a load connected to the battery; and
a control system connected to the battery and configured to:
in response to detecting that the battery is electrically connected to an external power supply, disconnect a load power supply circuit configured for the battery to supply power to the load; and
control the battery to be charged by the external power supply.

12. The UAV of claim 11, wherein the control system is further configured to:
during a process of charging the battery, keep a control system power supply circuit connected, the control system power supply circuit being configured for the battery to supply power to the control system.

13. The UAV of claim 12, wherein the control system is further configured to control the control system to enter a low-power sleeping mode.

14. The UAV of claim 11, wherein the UAV control system is further configured to, after controlling the battery to be charged:
detect that the battery is electrically disconnected from the external power supply; and
connect the load power supply circuit.

15. The UAV of claim 11, wherein:
the load power supply circuit includes an electronic switch electrically coupled between the battery and the load;
the control system is communicatively coupled with the electronic switch; and
the control system is further configured to control opening and closing of the electronic switch.

16. The UAV of claim 15, wherein the electronic switch includes a MOS transistor or a solid-state relay.

17. The UAV of claim 11, wherein the load includes at least one of a gimbal, a camera, an electronic speed control (ESC) circuit, a distance sensor, or a positioning sensor.

18. The UAV of claim 11, wherein the control system is further configured to:
in response to detecting that the UAV is in an operation state, disconnect the load power supply circuit.

19. The UAV of claim 11, wherein the control system is further configured to:
in response to detecting that the UAV is in a shutdown state, control the UAV to switch from the shutdown state to an operation state; and
disconnect the load power supply circuit after the UAV is switched to the operation state.

20. An unmanned aerial vehicle (UAV) charging control system comprising:
an external power supply; and
a UAV including:
a battery;
a load connected to the battery; and
a control system connected to the battery and configured to:
in response to detecting that the battery is electrically connected to the external power supply, disconnect a load power supply circuit configured for the battery to supply power to the load; and
control the battery to be charged by the external power supply.
